(19) United States
(12) Patent Application Publication
(10) Pub. No.: US 2017/0052413 A1
(43) Pub. Date: Feb. 23, 2017

(54) PHOTO-ALIGNMENT FILM REWORKING METHOD AND MANUFACTURING METHOD OF LIQUID CRYSTAL DISPLAY INCLUDING THE SAME

(71) Applicant: Samsung Display Co. Ltd., Yongin-city (KR)

(72) Inventors: Jin Soo JUNG, Hwaseong-si (KR); Suk Hoon KANG, Seoul (KR); Tae Ho KIM, Cheonan-si (KR); Jong Hwan JEON, Hwaseong-si (KR); In Ok KIM, Osan-si (KR); Baek Kyun JEON, Yongin-si (KR)

(21) Appl. No.: 15/018,839

(22) Filed: Feb. 8, 2016

(30) Foreign Application Priority Data
Aug. 20, 2015 (KR) 10-2015-0117059

(51) Int. Cl. G02F 1/1337; C09D 179/08; C09K 19/56

(52) U.S. Cl. CPC G02F 1/133788; G02F 1/133711; C09K 19/56; C09D 179/08

(57) ABSTRACT

A method of reworking a photo-alignment film for use in a liquid crystal display (LCD) includes, providing a substrate on which a photo-alignment film including a photo-reactive group is formed by irradiation of a first light polarized in a first direction, the photo-reactive group including cyclobutane dianhydride (CBDA) or a CBDA derivative and diamine; irradiating a second light polarized in a second direction, which is different from the first direction, onto the photo-alignment film; and treating the photo-alignment film with a splitting solution.

This application claims priority to Korean Patent Application No. 10-2015-0117059 filed on Aug. 20, 2015, and all the benefits accruing therefrom under 35 U.S.C. §119, the content of which in its entirety is incorporated herein by reference.

### BACKGROUND

1. Field of the Invention

The invention relates to a method of reworking a photo-alignment film for use in a liquid crystal display (LCD) and a method of manufacturing an LCD using the reworking method.

2. Description of the Related Art

A liquid crystal display (LCD), is a widely-used flat panel display which includes two substrates on which field-generating electrodes, such as pixel electrodes and a common electrode, are formed. A liquid crystal layer is interposed between the two substrates.

The LCD generates an electric field which determines the alignment direction of liquid crystal molecules in the liquid crystal layer by applying a voltage to the field-generating electrodes. The LCD displays an image by controlling the polarization of light incident upon the liquid crystal layer.

In order for the LCD to display an image, the liquid crystal molecules need to be uniformly aligned in a particular direction along the interface between the liquid crystal layer and the field-generating electrodes. The uniformity of the alignment of the liquid crystal molecules is a contributing factor for the display quality of the LCD. Accordingly, an anisotropic alignment film may be provided between the liquid crystal layer and the field-generating electrodes so as to properly align the liquid crystal molecules in one direction.

The anisotropic alignment film may be obtained by irradiating light onto a polymer alignment film so as to impart anisotropy to the polymer alignment film. A polymer having an optical functional group, such as cyclobutane, azobenzene, coumarin, imide, chalcone, or cinnamate, may be used in a photo-alignment method, and may be induced to have anisotropy through photoisomerization, photopolymerization or photolysis caused by the irradiation of polarized light.

A photo-alignment film having an optical functional group is formed on a display panel. If a defect is detected in the surface of the photo-alignment film, the photo-alignment film may be removed using an alkaline organic solvent, and a reworking process may be performed to form a new photo-alignment film. However, there remains a need for improved methods of reworking a photo-alignment film

### SUMMARY

When reworking a photo-alignment film, the higher the concentration of the alkaline organic solvent, the better the removal of a photo-alignment film, but the higher the risk of defects such as corrosion of metallic elements. On the other hand, the lower the concentration of the alkaline organic solvent, the lower the risk of corrosion, but the poorer the removal of a photo-alignment film. As a result, it may take a long time to rework a photo-alignment film.

Exemplary embodiments provide a method of reworking a photo-alignment film which is capable of improving the removal of a photo-alignment film so as to reduce the amount of time that it takes to a rework the photo-alignment film.

Exemplary embodiments also provide a method of reworking a photo-alignment film, which is capable of easily removing the photo-alignment film without causing corrosion of metallic elements within a liquid crystal display.

Exemplary embodiments also provide a manufacturing method of a liquid crystal display (LCD) including a method reworking a photo-alignment film.

According to an exemplary embodiment, there is provided a method of reworking a photo-alignment film reworking method including, providing a substrate on which a photo-alignment film including a photo-reactive group is formed by irradiation of first light polarized in a first direction, where the photo-reactive group includes cyclobutane dianhydride (CBDA) or a CBDA derivative and diamine; irradiating a second light polarized in a second direction, which is different from the first direction, onto the photo-alignment film; and treating the photo-alignment film with a splitting solution.

In an exemplary embodiment, providing the substrate may include preparing the substrate; coating an alignment agent including the photo-reactive group on the substrate; curing the alignment agent to form the photo-alignment film; irradiating the first light polarized in the first direction onto the photo-alignment film; and baking the photo-alignment film.

In an exemplary embodiment, curing of the photo-alignment film may include curing the alignment agent at a first temperature for a first amount of time; and curing the alignment agent at a second temperature higher than the first temperature, for a second amount of time longer than the first amount of time.

In an exemplary embodiment, the second direction may be perpendicular to the first direction.

In an exemplary embodiment, the second light may be an ultraviolet (UV) light having a wavelength of about 200 nm to about 300 nm.

In an exemplary embodiment, irradiating the second light, may include irradiating UV light having an exposure amount of about 0.5 J/cm² to about 5 J/cm².

In an exemplary embodiment, the splitting solution may include about 15.0% to about 19.0% by weight of ethanolamine and about 1.0% to about 5.0% by weight of tetramethylammonium hydroxide.

In an exemplary embodiment, treating the photo-alignment film with the splitting solution may include treating the photo-alignment film with the splitting solution for about 300 seconds or less.

In an exemplary embodiment, the method may further include removing the photo-alignment film after treating the photo-alignment film with the splitting solution, and washing the substrate with the photo-alignment film removed therefrom.

In an exemplary embodiment, the steps of irradiating the second light and the treating the photo-alignment film with the splitting solution may be performed at the same time.

According to an exemplary embodiment, a method of manufacturing a liquid crystal display (LCD) includes, providing a substrate on which a photo-alignment film including a photo-reactive group is formed by irradiation of first light polarized in a first direction, in which the photo-reactive group includes cyclobutane dianhydride (CBDA) or a CBDA derivative and diamine; inspecting the surface of the photo-alignment film to determine whether the photo-alignment film is defective; and reworking the photo-alignment film if the photo-alignment film is determined to be defective or forming a liquid crystal layer on the photo-alignment film if the photo-alignment film is determined to be normal, wherein the reworking the photo-alignment film includes: irradiating a second light polarized in a second direction, which is different from the first direction, onto the photo-alignment film; and treating the photo-alignment film with a splitting solution.

In an exemplary embodiment, providing the substrate, may include: preparing the substrate; coating an alignment agent including the photo-reactive group on the substrate; curing the alignment agent to form the photo-alignment film; irradiating the first light polarized in the first direction onto the photo-alignment film; and baking the photo-alignment film.

In an exemplary embodiment, curing the photo-alignment film, may include: curing the alignment agent at a first temperature for a first amount of time; and curing the alignment agent at a second temperature higher than the first temperature, for a second amount of time longer than the first amount of time.

In an exemplary embodiment, the second direction may be perpendicular to the first direction.

In an exemplary embodiment, the second light may be UV light having a wavelength of about 200 nm to about 300 nm.

In an exemplary embodiment, irradiating the second light may include irradiating UV light having an exposure amount of about 0.5 J/cm² to about 5 J/cm².

In an exemplary embodiment, the splitting solution may include about 15.0% to about 19.0% by weight of ethanolamine and about 1.0% to about 5.0% by weight of tetramethylammonium hydroxide.

In an exemplary embodiment, treating the photo-alignment film with the splitting solution may include treating the photo-alignment film with the splitting solution for about 300 seconds or less.

In an exemplary embodiment, the method further includes removing the photo-alignment film after treating the photo-alignment film with the splitting solution and washing the substrate with the photo-alignment film removed therefrom.

In an exemplary embodiment, the steps of irradiating the second light and the treating the photo-alignment film with the splitting solution may be performed at the same time.

According to the exemplary embodiments, UV light is irradiated onto an anisotropic photo-alignment film thereby photo-decomposing the main chain of the polymer in the anisotropy direction of the photo-alignment film. Thus, the photo-alignment film can be easily removed by an alkaline organic solvent.

In addition, since the removal of the photo-alignment film can be improved without the need to increase the concentration of the organic solvent, corrosion of metallic elements can be minimized.

Moreover, an LCD with an improved reliability can be fabricated by removing a defective photo-alignment film and forming a new photo-alignment film through a reworking process.

Other features and exemplary embodiments will be apparent from the following detailed description, the drawings, and the claims.

### BRIEF DESCRIPTION OF THE DRAWINGS

The above and other aspects, advantages and features of this disclosure will become more apparent by describing in further detail exemplary embodiments thereof with reference to the accompanying drawings, in which:

FIG. 1 is a plan view of a pixel of an exemplary embodiment of a liquid crystal display (LCD).

FIG. 2 is a cross-sectional view taken along line II-II′ of FIG. 1.

FIG. 3 is a flowchart of an exemplary method of reworking a photo-alignment film and an exemplary method of manufacturing an LCD including the photo-alignment film reworking method.

FIG. 4 is a perspective view illustrating a process of aligning a photo-alignment film through irradiation with the first light polarized in a first direction.

FIG. 5 is a flowchart of an exemplary method of reworking a photo-alignment film reworking and a method of manufacturing method an LCD including the photo-alignment film reworking method.

FIG. 6 shows microphotographs of the surfaces of substrates prepared in accordance with Embodiments 1 to 5.

FIG. 7 shows microphotographs of the surfaces of substrates prepared in accordance with Comparative Examples 1 to 5.

FIG. 8 is a graph illustrating the amount of time (seconds) that it takes to completely remove a photo-alignment film in for each of Embodiments 1 to 5 and Comparative Example 4.

FIGS. 9A and 9B show microphotographs of a contact hole portion of a substrate prepared in accordance with Comparative Example 6.

FIGS. 10A and 10B show focused ion beam-scanning electron microscope (FIB-SEM) images of the contact hole portion of the substrate prepared in accordance with Comparative Example 6.

FIG. 11 is a graph illustrating the amount of time (seconds) that it takes to completely remove a photo-alignment film for each of Embodiment 3 and Comparative Examples 4, 7, and 8.

### DETAILED DESCRIPTION

Features of the inventive concept and methods of accomplishing the same may be understood more readily by reference to the following detailed description of various embodiments and the accompanying drawings.

The inventive concept may, however, be embodied in many different forms and should not be construed as being limited to the embodiments set forth herein. Rather, these embodiments are provided so that this disclosure will be thorough and complete and will fully convey the concept of the inventive concept to those skilled in the art, and the inventive concept will only be defined by the appended claims.

In the drawings, the thickness of layers and regions are exaggerated for clarity. It will be understood that when an element or layer is referred to as being “on,” “connected to” or “coupled to” another element or layer, the element or layer can be directly on, connected or coupled to another element or layer or intervening elements or layers. In contrast, when an element is referred to as being “directly on,” “directly connected to” or “directly coupled to” another element or layer, there are no intervening elements or layers present. As used herein, connected may refer to elements being physically, electrically and/or fluidly connected to each other.

Like numbers refer to like elements throughout.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Spatially relative terms, such as “below,” “lower,” “under,” “above,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “beneath” relative to other elements or features would then be oriented “above” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, including “at least one,” unless the context clearly indicates otherwise. “Or” means “and/or.” As used herein, the term “and/or” includes any and all combinations of one or more of the associated listed items. It will be further understood that the terms “comprises,” “comprising,” “includes” and/or “including,” when used in this specification, specify the presence of stated features, integers, operations, elements, and/or components, but do not preclude the presence or addition of one or more other features, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Exemplary embodiments will hereinafter be described with reference to the accompanying drawings.

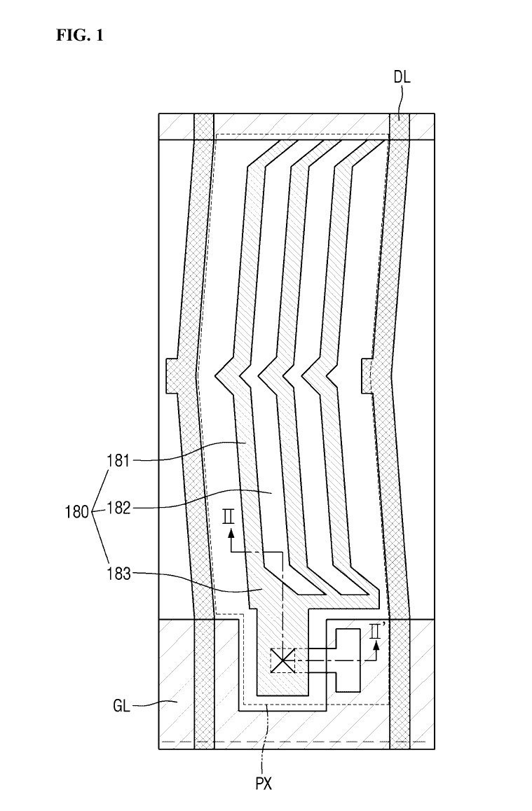

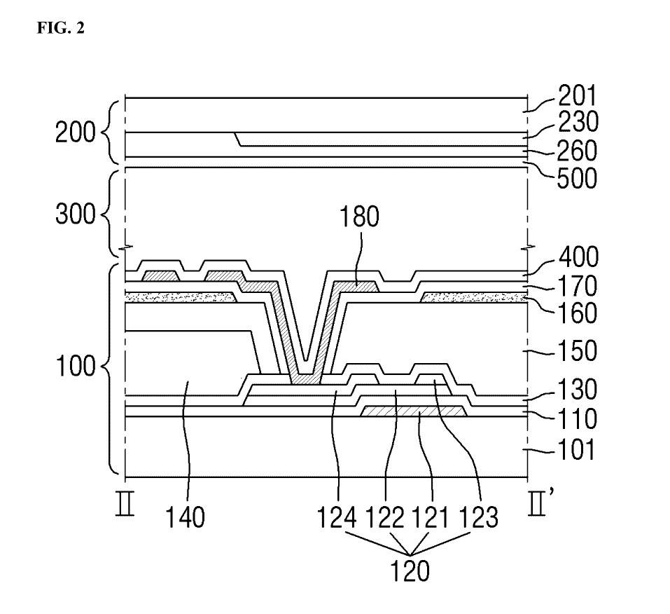

FIG. 1 is a plan view of a pixel of an exemplary embodiment of a liquid crystal display (LCD) manufactured as described herein. FIG. 2 is a cross-sectional view taken along line II-II′ of FIG. 1.

Referring to FIGS. 1 and 2, the LCD includes a first substrate 100, a second substrate 200, which is spaced apart from, and faces, the first substrate 100, and a liquid crystal layer 300 interposed between the first and second substrates 100 and 200. The liquid crystal layer 300 may include liquid crystal molecules with positive dielectric anisotropy, but is not limited thereto. The liquid crystal layer 300 may also include liquid crystal molecules with negative dielectric anisotropy.

The first substrate 100 may be a lower substrate where thin-film transistors (TFT) are formed. The structure of the first substrate 100 will hereinafter be described. The first substrate 100 may include a first base substrate 101, a plurality of TFTs 120, color filters 140, a passivation layer 130, a plurality of insulating layers 110, 150, and 170, a common electrode 160 and a pixel electrode 180. Each TFT in the plurality of TFTs 120 may include a gate electrode 121, a source electrode 123, a drain electrode 124, and a semiconductor layer 122.

The first base substrate 101 may be a transparent or opaque insulating substrate and may be formed of a material having excellent transmissivity, excellent heat resistance and excellent chemical resistance. In an exemplary embodiment, the first base substrate 101 may be a silicon substrate, a glass substrate, or a plastic substrate.

A plurality of gate lines GL and a plurality of data lines DL, which intersect the gate lines GL, may be formed on the first base substrate 101. The gate lines GL may extend substantially in a row direction on the first base substrate 101 and may provide a gate signal provided by a gate driver (not illustrated). The gate lines GL may be formed by forming a first metal layer and patterning the first metal layer. The metal layer may be formed using an element including one or more of tantalum (Ta), tungsten (W), titanium (Ti), molybdenum (Mo), aluminum (Al), copper (Cu), silver (Ag), chromium (Cr), neodymium (Nd), an alloy thereof, and a compound of the element. The first metal layer may be patterned using a mask process or another patterning process.

The gate insulating layer 110 is disposed on the gate lines GL and on the entire surface of the first base substrate 101. The gate insulating layer 110 may be formed of an insulating material and may electrically insulate a layer disposed at the top of the gate insulating layer from a layer disposed at the bottom gate insulating layer. The gate insulating layer 110 may be formed of, for example, silicon nitride (SiNx), silicon oxide (SiOx), silicon nitride oxide (SiNxOy), or silicon oxynitride (SiOxNy), and may have a multilayer structure including two or more insulating films having different physical properties. In some exemplary embodiments, the gate insulating layer 110 may be formed by a chemical vapor deposition (CVD) process.

The semiconductor layer 122 is formed on the gate insulating layer 110. The semiconductor layer 122 may be disposed in an area overlapping at least part of the gate electrode 121 and may function as the channel of a TFT. The semiconductor layer 122 may include a semiconductor material such as amorphous silicon, polycrystalline silicon or an oxide semiconductor, and may allow or block the transmission of a current according to a voltage provided to the gate electrode 121.

An ohmic contact layer (not illustrated) may be disposed in an area overlapping at least part of the semiconductor layer 122. The ohmic contact layer may contain an n+hydrogenated amorphous silicon material doped with a high concentration of n-type impurities, or silicide.

The data lines DL may be disposed on the gate insulating layer 110. The data lines DL may extend substantially in a column direction to intersect the gate lines GL, and may provide a data signal provided by a data driver (not illustrated). The data lines DL may be formed by forming a second metal layer and patterning the second metal layer. The second metal layer may be formed using a refractory metal including one or more of Ag, gold (Au), Cu, nickel (Ni), platinum (Pt), palladium (Pd), iridium (Ir), rhodium (Rh), W, Al, Ta, Mo, cadmium (Cd), zinc (Zn), iron (Fe), Ti, Si, germanium (Ge), zirconium (Zr), barium (Ba), an alloy thereof, and a nitride thereof.

A plurality of pixel regions PX may be defined by the gate lines GL and the data lines DL, which intersect the gate lines GL. The pixel regions PX may be independently driven according to their respective gate lines GL and their respective data lines DL. Each TFT 120 may include the gate electrode 121, the semiconductor layer 122, the source electrode 123, and the drain electrode 124, and the TFTs 120 may be disposed to correspond to the pixel regions PX, respectively. The gate electrode 121 may be formed as one body with one of the gate lines GL without a physical boundary therebetween. The semiconductor layer 122 and the ohmic contact layer are as mentioned above.

The source electrode 123 and the drain electrode 124 may be disposed on the ohmic contact layer, on an area overlapping at least part of the semiconductor layer 122, and on the gate insulating layer 110. The source electrode 123 and the drain electrode 124 may be formed by making and patterning the second metal layer, which is used to form the data lines DL. The source electrode 123 may protrude from one of the data lines DL toward the gate electrode 121 and may transmit a data signal provided by the corresponding data line DL to the drain electrode 124 through the semiconductor layer 122. The drain electrode 124 may be spaced from the source electrode 123 and may be disposed over at least a portion of the gate electrode 121 and the semiconductor layer 122.

The passivation layer 130 may be disposed on the data lines DL and across the entire surface of the TFT 120. The passivation layer 130 may be an organic layer and/or an inorganic layer and may have a single-layer or double-layer structure. The passivation layer 130 may prevent wiring formed therebelow and the semiconductor layer 122 of each of the TFTs 120 from coming into direct contact with an organic material.

The color filters 140 may be formed on the passivation layer 130 to correspond to the pixel regions PX, respectively. More specifically, the color filters 140 may be disposed among the data lines DL. Each of the color filters 140 may selectively transmit light of a particular wavelength range therethrough. Color filters 140 in different colors that transmit different wavelength bands of light therethrough, may be respectively disposed in adjacent pixel regions PX. In an exemplary embodiment, the color filters 140 may be disposed on the TFTs 120 so as to form a color filter-on-array (COA) structure. In an alternative exemplary embodiment, an array-on-color filter (AOC) structure may be provided in which the color filters 140 are disposed below the TFTs 120. In another alternative exemplary embodiment, the color filters 140 may be provided on an upper substrate.

The first insulating layer 150 may be disposed on the color filters 140 and the TFTs 120. The first insulating layer 150 may include an organic material. The first insulating layer 150 may make uniform the heights of the elements stacked on the first base substrate 101. Also, the first insulating layer 150 may prevent the mixing of colors between the color filters 140 and may prevent the TFTs 120 from contacting other elements.

The common electrode 160 may be disposed on the first insulating layer 150. The common electrode 160 may be a transparent electrode obtained by forming and patterning a third metal layer. The common electrode 160 may be formed of, for example, indium tin oxide (ITO) or indium zinc oxide (IZO), but is not limited thereto. The common electrode 160 may form a fringe field together with the pixel electrodes 180 and may thus control liquid crystal molecules in the liquid crystal layer 300. The common electrode 160 may be disposed to overlap almost the entire pixel regions PX. The second insulating layer 170 may be disposed on the common electrode 160 and may insulate the common electrode 160 and the pixel electrodes 180 from each other.

A contact hole may be formed through the first and second insulating layers 150 and 170 so as to expose part of the drain electrode 124 therethrough. The drain electrode 124 may be electrically connected to one of the pixel electrodes 180 through the contact hole.

The pixel electrodes 180 may be disposed on the second insulating layer 170. The pixel electrodes 180 may be disposed to correspond to the pixel regions PX, respectively. As mentioned above, the pixel electrodes 180 may form a fringe field together with the common electrode 160, which is disposed below the pixel electrodes 180, and may thus control the liquid crystal molecules in the liquid crystal layer 300. The pixel electrodes 180, like the common electrode 160, may be transparent electrodes and may be formed by forming and patterning a fourth metal layer. Each of the pixel electrodes 180 may include a plurality of branch electrodes 181, a plurality of openings 182 formed among the branch electrodes 181, and a connecting electrode 183, which connects first ends or second ends of the branch electrodes 181 together. The openings 182 may be formed as bars having at least two bent portions. The branch electrodes 181 may have a shape corresponding to the shape of the openings 182. The openings 182 may have a symmetrically bent shape with respect to the center of a corresponding pixel region PX. Thus, a fringe field may be formed in different directions in the upper and lower parts of each of the pixel regions PX. Accordingly, two domains may be formed in each of the pixel regions PX. The movement of liquid crystal molecules may vary from one domain to another domain of each of the pixel regions PX, and as a result, the alignment of the long axes of the liquid crystal molecules may also vary from one domain to another domain of each of the pixel regions PX. Therefore, a color shift phenomenon at a particular azimuth angle may be reduced.

The second substrate 200 will hereinafter be described. The second substrate 200 may be an upper substrate. The second substrate 200 may include a second base substrate 201, a light-shielding member 230, and an overcoat layer 260. The second base substrate 201 may be formed of the same material as the first base substrate 101.

The light-shielding member 230 may be formed on the second base substrate 201. The light-shielding member 230 may be disposed among the color filters 140 to prevent a light leakage defect. For example, the light-shielding member 230 may be a black matrix. Alternatively, the light-shielding member 230 may be formed on the first substrate 100. The overcoat layer 260 may be disposed on the light-shielding member 230. The overcoat layer 260 may prevent the light-shielding member 230 from being detached from the second base substrate 201 and may make uniform the heights of the elements stacked on the second base substrate 201.

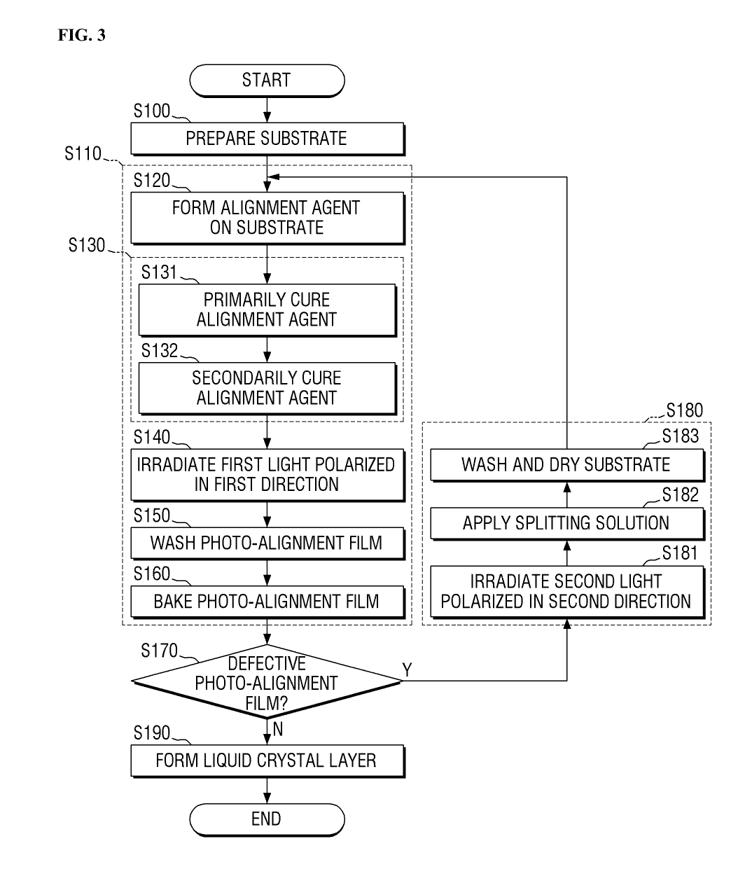

A first photo-alignment film 400 may be disposed on the pixel electrodes 180 of the first substrate 100, and a second photo-alignment film 500 may be disposed on the overcoat layer 260 of the second substrate 200. The first and second photo-alignment films 400 and 500 may be horizontal photo-alignment films, but is not limited thereto. That is, the first and second photo-alignment films 400 and 500 may be vertical photo-alignment films. The liquid crystal molecules in the liquid crystal layer 300 near the first and second photo-alignment films 400 and 500 may be aligned in a particular direction in a plan view. The first and second photo-alignment films 400 and 500 may be formed by applying an alignment agent onto the first and second substrates 100 and 200, respectively, and irradiating partially-polarized or completely-polarized light so as to cause a photoreaction. The first and second photo-alignment films 400 and 500 may be obtained by a photo-alignment film reworking process. The photo-alignment film reworking process will be described later with reference to FIG. 3.

The material of the first and second photo-alignment films 400 and 500 is not particularly limited as long as it can impart anisotropy to the photo-alignment films 400 and 500. For example, the first and second photo-alignment films 400 and 500 may contain a polymer with a photo-reactive group, and in response to light being irradiated onto the photo-reactive group, the first and second photo-alignment films 400 and 500 may have anisotropy that varies depending on a direction of the irradiation of the light. In an exemplary embodiment, the polymer may include one or more of polyamic acid, a partially imidized polyamic acid polymer, polyimide obtained by cyclodehydrating polyamic acid, and a combination thereof.

The photo-reactive group may be a functional group capable of causing photodecomposition, in which case, the first and second photo-alignment films 400 and 500 may be formed of a cyclobutane dianhydride (CBDA) or a CBDA derivative, polyamic acid comprising diamine, polyimide, or a combination thereof. Specifically, the CBDA may be cyclobutanecarboxylic acid dianhydride.

The CBDA or the CBDA derivative may be represented by Formula 1:

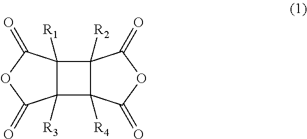

where R₁, R₂, R₃, and R₄ each independently represent a hydrogen atom, a fluorine atom, an alkyl group having one to six carbon atoms, or an alkoxy group.

The diamine may be an aromatic diamine such as p-phenylenediamine, m-phenylenediamine, 2,5-diamino toluene, 2,6-diamino toluene, 4,4′-diamino biphenyl, 3,3′-dimethyl-4, 4′-diamino biphenyl, 3,3′-diamino-4,4′-dimethoxy-biphenyl, diamino diphenyl methane, diamino diphenyl ether, 2,2′-diamino diphenyl propane, bis(3,5-diethyl-4-aminophenyl) methane, diamino diphenyl sulfone, diamino benzophenone, diaminonaphthalene, 1,4-bis(4-aminophenoxy) benzene, 1,4-bis (4-aminophenyl) benzene, 9,10-bis(4-aminophenyl)anthracene, 1,3-bis(4-aminophenoxy)benzene, 4,4′-bis(4-aminophenoxy)diphenyl sulfone, 2,2-bis[4-(4-aminophenoxy) phenyl]propane, 2,2-bis(4-aminophenyl) hexafluoropropane, or 2,2-bis[4-(4-aminophenoxy) phenyl]hexafluoropropane, an alicyclic diamine such as bis(4-aminocyclohexyl)methane or bis(4-amino-3-methylcyclohexyl)methane, or an aliphatic diamine such as tetramethylene diamine or hexamethylene diamine, but is not limited thereto.

Polyimide and polyamic acid obtained by copolymerizing the CBDA or the CBDA derivative and the diamine may be represented by Formulas (2) and (3), respectively:

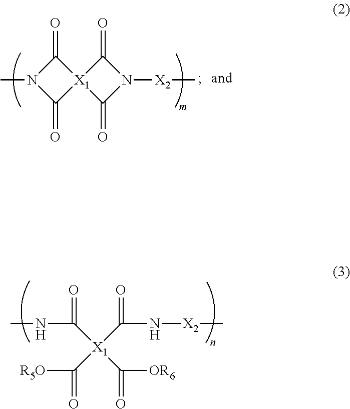

where X₁ is CBDA or a CBDA derivative, X₂ is diamine, R₅ and R₆ each independently represent hydrogen, a substituted or unsubstituted alkyl having 1 to 20 carbon atoms, or a substituted or unsubstituted aryl having 6 to 40 carbon atoms, and m and n are natural numbers greater than 0.

The first and second photo-alignment films 400 and 500, which are formed on the first and second substrates 100 and 200, respectively, may be formed using the same material or using different materials.

A method of reworking a photo-alignment film will hereinafter be described with reference to FIG. 3.

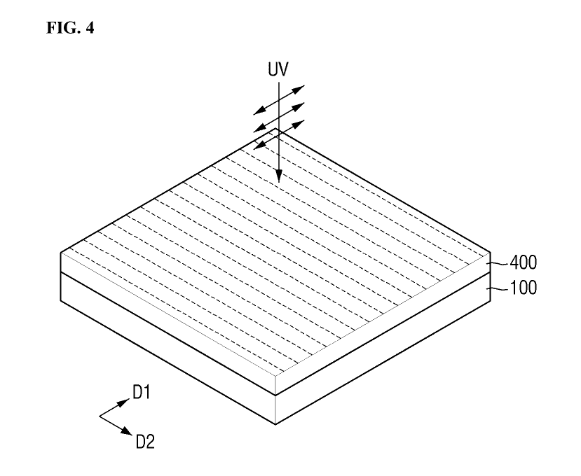

FIG. 3 is a flowchart of an exemplary embodiment of a method of reworking a photo-alignment film various process (operation) steps and an exemplary method of manufacturing an LCD including the photo-alignment film reworking method. FIG. 4 is a perspective view illustrating a process of aligning a photo-alignment film through the irradiation of first light, shown in FIG. 3. As used herein, the term “alignment film reworking method”, used interchangeably with “method of reworking an alignment film,” indicates a method involving forming an alignment film, removing the alignment film upon the detection of a defect from the alignment film, and forming a new alignment film. Thus it is understood that an “alignment film reworking method” or a “method of reworking an alignment film” involves forming an alignment film and removing the alignment film.

Referring to FIG. 3, the photo-alignment film reworking method may generally include forming a photo-alignment film S110 and removing the photo-alignment film S180.

More specifically, a substrate is prepared (operation S100). The substrate may be a lower substrate where TFTs are formed and/or an upper substrate facing the lower substrate.

An alignment agent is formed (i.e. coated) on the substrate (operation S120). The alignment agent may comprise a monomer or a precursor of a polymer having a photo-reactive group capable of causing photodecomposition. In an exemplary embodiment, the alignment agent may comprise a CBDA or a CBDA derivative and diamine. In addition to the monomer or the precursor of the polymer, the alignment agent may further include a solvent, and may also contain a material such as a photoinitiator and/or a crosslinking agent. The crosslinking agent may induce a competitive reaction so as for the diamine to absorb light during photodecomposition and may thus effectively cause photodecomposition.

The alignment agent may be applied onto the substrate by spin coating, slit coating or inkjet printing, but is not limited thereto.

Thereafter, the alignment agent is cured (operation S130). Operation S130 may include primarily curing the alignment agent (operation S131) and secondarily curing the alignment agent (operation S132). Operation S131 may be a procuring operation, and operation S132 may be a main or post-curing operation. Operation S130 may be performed by sequentially performing operations S131 and S132. Alternatively, in some exemplary embodiments, operations S131 and S132 may be performed substantially at the same time with no particular distinction therebetween.

Operation S131 may include removing the solvent of the alignment agent. In operation S131, the alignment agent may be cured at a temperature of about 50° C. [symbol] o about 80° C. In operation S131, the alignment agent may be cured for a time of about 60 seconds to about 300 seconds, or more specifically, for a time of about 65 seconds to about 120 seconds.

Operation S132 may include substantially completing the polymerization of the monomer or the precursor of the polymer included in the alignment agent so as to form a photo-alignment layer. In operation S132, the alignment agent may be cured at a higher temperature than in operation S131 and for a longer period of time than in operation S131. In operation S132, the alignment agent may be cured at a temperature of about 150° C. [symbol] o about 270° C. In operation S132, the alignment agent may be cured for a time of about 500 seconds to about 1500 seconds, or more specifically, for a time of about 700 seconds to about 1300 seconds.

Thereafter, a first light, which is polarized in a first direction, is irradiated onto the photo-alignment film (operation S140). Operation S140 may include aligning the photo-alignment film through the irradiation of linearly polarized light. The first light may cause a reaction of the photo-reactive group of the alignment agent. The first light may be at least one of ultraviolet (UV) light, infrared (IR) light, far infrared (FIR) light, an electron beam, and radiation. In an exemplary embodiment, the first light may be UV light. For example, UV light having a wavelength of about 240 nm to about 270 nm, or specifically, of about 250 nm to about 260 nm, may be irradiated. In operation S140, the first light may be irradiated onto the photo-alignment with an exposure amount of about 0.3 J/cm² to about 1.5 J/cm², or more specifically, about 0.4 J/cm² to about 1.2 J/cm². The exposure amount may be controlled by the duration of time in which the first light is irradiated onto the photo-alignment film. The specific exposure amount may vary according to the driving mode of an LCD, the physical properties of the material of the photo-alignment layer, and the like.

Referring to FIG. 4, in operation S140, UV light polarized in the first direction D1 is irradiated onto a photo-alignment film including an isotropic polymer main chain. In response, photodecomposition may occur in the first direction D1 (i.e. an absorption axis direction), and thus, the photo-alignment film may become anisotropic in a second direction D2, which is perpendicular to the first direction D1. More specifically, the bond of the cyclobutane ring of polyimide aligned in the first direction D1 may be broken, and as a result, the polyimide may be decomposed into two maleimides having an alkene structure. On the other hand, no photodecomposition may be induced for polyimide molecules aligned in the second direction D2. Accordingly, anisotropy may be imparted to the photo-alignment film by aligning polyimide molecules mainly in the second direction D2. The photodecomposition of polyimide may be represented by, but is not limited to, the process illustrated in Formula 4:

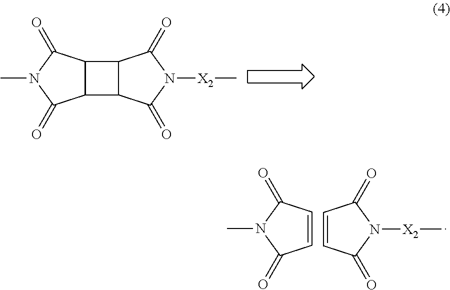

Referring back to FIG. 3, after the irradiation of the first light, a process of washing the photo-alignment film, i.e., a primary washing process, is performed (operation S150). The primary washing process may use a solvent, and may be performed by immersing the substrate and the photo-alignment film in the solvent or by applying the solvent onto the substrate and the photo-alignment film, but is not limited thereto. The solvent used in the primary washing process may be deionized (DI) water.

Thereafter, the photo-alignment film is baked (operation S160). Operation S160 may be for stabilizing unstable functional groups after light exposure to improve the force of alignment. By baking the photo-alignment film, any solvent remained in the photo-alignment film may be completely removed, and the polymerization of the photo-alignment film may be completed. Accordingly, the heat resistance of the photo-alignment film may be improved. In operation S160, the photo-alignment film may be baked at a temperature of about 150° [symbol] o about 270° C. In operation S160, the photo-alignment film may be baked for a time of about 700 seconds to 3000 seconds, or more specifically, for about 800 seconds to about 2500 seconds.

Although not specifically illustrated, additional process steps of cooling the substrate and the photo-alignment film and of dry-washing the photo-alignment film, i.e., a secondary washing process, may be performed after operation S160. The secondary washing process may be a dry washing process. For example, the photo-alignment film may be dry washed by spraying a gas with the use of ultrasonic waves, by creating a vacuum, or by using an air knife, but is not limited thereto. The secondary washing process may effectively prevent any defects that may be caused by fume particles produced during operation S160.

Thereafter, the surface of the photo-alignment film is inspected (operation S170) for any defects which may be present. The defects may be, for example, pinholes or foreign materials.

In response to a defect being detected in the surface of the photo-alignment film Y, the photo-alignment film is removed (operation S180). A new photo-alignment film may then be formed through a reworking process, thereby improving the reliability of an LCD including the film. Operation S180 will hereinafter be described in detail.

In response to a defect being detected in the surface of the photo-alignment film (path Y), a second light, which is polarized in the second direction, is irradiated onto the photo-alignment film (operation S181). The second light may cause a reaction of the photo-reactive group included in the photo-alignment film and may be at least one of UV light, IR light, FIR light, an electron beam, and radiation. In an exemplary embodiment, the second light may be UV light. Specifically, UV light having a wavelength of about 240 nm to about 270 nm, or more specifically, a wavelength of about 250 nm to about 260 nm, may be irradiated. In operation S181, the second light irradiated onto the photo-alignment film may have an exposure amount of about 0.1 J/cm² to about 13 J/cm², or more specifically, about 1 J/cm² to about 10 J/cm².

The second light may be UV light polarized in the second direction D2, which is perpendicular to the light polarized in the first direction D1, but is not limited thereto. That is, the second light may be UV light polarized in the first direction D1, circularly or elliptically polarized UV light, or non-polarized UV light. When the second light is polarized in the second direction D2 and is thus perpendicular to the UV light used in operation S140, photodecomposition may be induced along an axis extended in the second direction D2 in areas where photodecomposition has not yet occurred in operation S140. Accordingly, the main chain of the polymer included in the photo-alignment film may be decomposed not only along an axis extended in the first direction D1, but also along the axis extended in the second direction D2. As a result, the removal of the photo-alignment film may be facilitated by a subsequent process of applying a stripping (splitting) solution.

Thereafter, a splitting solution is applied (operation S182). As used herein, the term “splitting solution” is used interchangeably with the term “stripping solution” and refers to a solution having a polymer stripping or dissolution action capable of hydrolyzing the imide bond in the main chain of polyimide. In some exemplary embodiments, the substrate on which the photo-alignment film is formed may be immersed in the stripping solution. The stripping solution may be a solvent comprising an alkaline compound such as an alkali metal hydroxide or an alkaline earth metal hydroxide, an organic ammonium compound such as ammonia or tetramethylammonium hydroxide, an amine compound, an ethylene glycol aqueous solution, alcohol, and/or deionized (DI) water, but is not limited thereto.

Thereafter, the process steps of washing the substrate with the photo-alignment film removed therefrom (i.e., a tertiary washing process), and drying the substrate are performed (operation S183), thereby completing the removal of the photo-alignment film, i.e., operation S180. The tertiary washing process may use a solvent, and may be performed by immersing the substrate in the solvent or by applying the solvent onto the substrate, but is not limited thereto. The solvent used in the tertiary washing process may be DI water.

Operation S183 may be repeatedly performed twice. For example, in operation S183, the substrate may be washed with DI water, and may then be dried with a slit jet. Thereafter, the substrate may be washed again, and may then be dried with an air knife. However, the tertiary washing process is not limited to these methods. That is, ultrasonic washing may also be used in operation S183. By subjecting the substrate to operation S183, any stripping solution remaining on the substrate may be completely washed off, and parts of the photo-alignment film that are yet to be completely decomposed may be physically removed from the substrate. Accordingly, the substrate may return to its original state.

Thereafter, operation S110 including operations S120, S130, S140, S150, and S160 may be performed again so as to form a new photo-alignment film, and following formation, the new photo-alignment film is subjected to operation S170 to be inspected for any defects. Thereafter, if no defects are detected in the new photo-alignment film (path N), a liquid crystal layer is formed on the substrate (operation S190), thereby fabricating an LCD. Operation S190 may be performed by dropping a liquid crystal composition onto the substrate and bonding the substrate to another substrate, or by bonding the substrate to another substrate and injecting liquid crystal molecules between the two substrates.

An alternative exemplary embodiment of a photo-alignment film reworking method and a method of manufacturing an LCD including the exemplary photo-alignment film reworking method, will hereinafter be described.

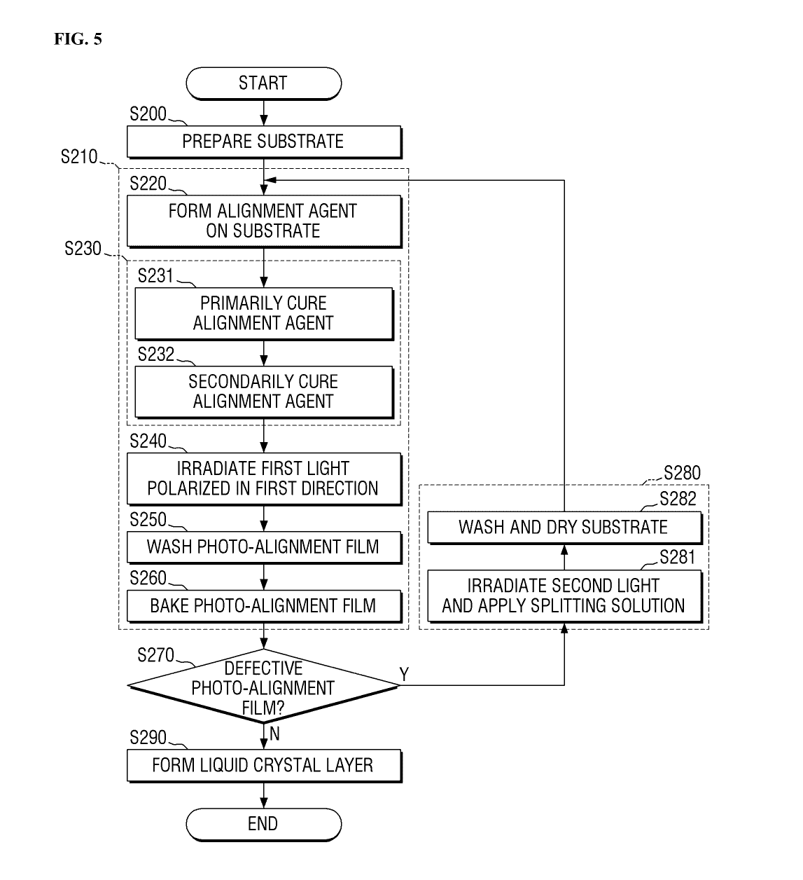

FIG. 5 is a flowchart of an exemplary method of reworking a photo-alignment film and a method of manufacturing an LCD including the exemplary photo-alignment film reworking method.

Referring to FIG. 5, in an exemplary embodiment, a photo-alignment film reworking method (operation S210) includes forming an alignment agent on a substrate (operation S220), primarily curing the alignment agent (operation S231), secondarily curing the alignment agent (operation S232), aligning a photo-alignment film by irradiating first light polarized in a first direction (operation S240), onto the photo-alignment film, washing the photo-alignment film (operation S250), and baking the photo-alignment film (operation S260). Operation S210 is the same as operation S110 of FIG. 3, and thus, a detailed description thereof will be omitted.

Thereafter, the surface of the photo-alignment film is inspected (operation S270) for any defects, for example, pinholes or foreign materials.

In response to a defect being detected from the surface of the photo-alignment film (path Y), the photo-alignment film is removed (operation S280). More specifically, in response to a defect being detected in the surface of the photo-alignment film (path Y), a second light, which is polarized in a second direction, is irradiated onto the photo-alignment film, and at the same time, a stripping solution is applied onto the photo-alignment film (operation S281). The operating conditions for operation S281 are substantially the same as described in the photo-alignment film reworking method of FIG. 3. By performing the irradiation of the second light and the application of the stripping solution at the same time, the amount of time that it takes to rework a photo-alignment film may be reduced. Further, the structure of the washing equipment performing the removal and the process of reworking of the photo-alignment film may be simplified. It is also possible to prevent incomplete decomposition of a photo-alignment film that may occur depending on conditions of the irradiation of light.

Thereafter, the substrate with the photo-alignment film removed therefrom is washed and dried (operation S282), thereby completing the removal of the photo-alignment film, i.e., operation S280.

Thereafter, operation S210, including individual operations S220, S231, S232, S240, S250, and S260, is performed again so as to form a new photo-alignment film, and the new photo-alignment film is also subjected to operation S270 to be inspected for any defects. Thereafter, if no defects are detected from the new photo-alignment film (path N), a liquid crystal layer is formed on the substrate (operation S190), thereby fabricating an LCD.

The invention will hereinafter be described in further detail comparing Embodiments 1 to 5 and Comparative Examples 1 to 8.

### Embodiment 1

An alignment agent containing CBDA and a diamine-based compound in a molar ratio of about 1:1 was formed on a substrate with TFTs arranged thereon. Thereafter, a photo-alignment film formation process was performed by primarily curing the alignment agent at a temperature of 60° C. for 60 seconds, secondarily curing the alignment agent at a temperature of 230° C. for 800 seconds, linearly polarizing UV light having a wavelength of 254 nm (i.e. first UV light), irradiating the linearly polarized UV light onto the substrate with an exposure amount of 0.5 J/cm², and baking at a temperature of 230° C. for 1800 seconds. Thereafter, a second UV light having the same wavelength (i.e. 254 nm) as the linearly polarized UV light but polarized perpendicular to the linearly polarized UV light, was irradiated onto the photo-alignment film with an exposure amount of about 1 J/cm². A stripping solution containing 19.0% by weight of ethanolamine and 5.0% by weight of tetramethylammonium hydroxide was applied onto the photo-alignment film. At 300 seconds following the application of the stripping solution, a photo-alignment film removal process was performed by washing and drying the substrate.

### Embodiment 2

Embodiment 2 is the same as Embodiment 1 except that during a photo-alignment film removal process, the second UV light was irradiated with an exposure amount of 2 J/cm² and the stripping solution was applied for 180 seconds.

### Embodiment 3

Embodiment 3 is the same as Embodiment 1 except that during a photo-alignment film removal process, the second UV light was irradiated with an exposure amount of 3 J/cm² and the stripping solution was applied for 180 seconds.

### Embodiment 4

Embodiment 4 is the same as Embodiment 1 except that during a photo-alignment film removal process, the second UV light was irradiated with an exposure amount of 4 J/cm² and the stripping solution was applied for 60 seconds.

### Embodiment 5

Embodiment 5 is the same as Embodiment 1 except that during a photo-alignment film removal process, the second UV light was irradiated with an exposure amount of 5 J/cm² and the stripping solution was applied for 60 seconds.

### Comparative Example 1

An alignment agent containing CBDA and a diamine-based compound in a molar ratio of about 1:1 was formed on a substrate with TFTs arranged thereon. Thereafter, a photo-alignment film formation process was performed by primarily curing the alignment agent at a temperature of 60° C. for 60 seconds, secondarily curing the alignment agent at a temperature of 230° C. for 800 seconds, linearly polarizing UV light having a wavelength of 254 nm, irradiating the linearly polarized UV light onto the substrate with an exposure amount of 0.5 J/cm², and baking at a temperature of 230° C. for 1800 seconds. Thereafter, a stripping solution containing 19.0% by weight of ethanolamine and 5.0% by weight of tetramethylammonium hydroxide was applied onto the photo-alignment film. After 900 seconds following the application of the stripping solution, a photo-alignment film removal process was performed by washing and drying the substrate.

### Comparative Example 2

Comparative Example 2 is the same as Comparative Example 1 except that during the photo-alignment film removal process, the stripping solution was applied for 1200 seconds.

### Comparative Example 3

Comparative Example 3 is the same as Comparative Example 1 except that during a photo-alignment film removal process, the stripping solution was applied for 1500 seconds.

### Comparative Example 4

Comparative Example 4 is the same as Comparative Example 1 except that during a photo-alignment film removal process, the a stripping solution was applied for 1800 seconds.

### Comparative Example 5

Comparative Example 5 is the same as Comparative Example 1 except that during a photo-alignment film removal process, the stripping solution was applied for 2100 seconds.

### Comparative Example 6

Comparative Example 6 is the same as Comparative Example 1 except that during a photo-alignment film removal process, a stripping solution containing 23.0% by weight of ethanolamine and 7.0% by weight of tetramethylammonium hydroxide was applied for about 360 seconds.

### Comparative Example 7

Comparative Example 7 is the same as Comparative Example 3 except that the polarization direction of the first UV light irradiated during the photo-alignment film formation process is parallel to the polarization direction of the second UV light irradiated during a photo-alignment film removal process.

### Comparative Example 8

Comparative Example 8 is the same as Comparative Example 3 except that non-polarized UV light was irradiated during the photo-alignment film removal process.

### Experimental Example 1

### Observing Removal of Alignment Film and Measuring Removal Time

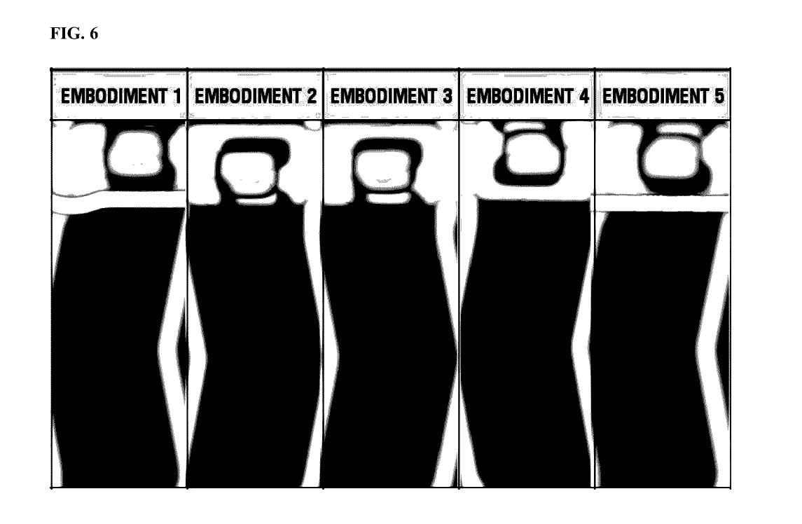

The surfaces of the substrates prepared according to Embodiments 1 to 5 and Comparative Examples 1 to 5 were observed with a microscope, and the results of the observation are as illustrated in FIGS. 6 to 8.

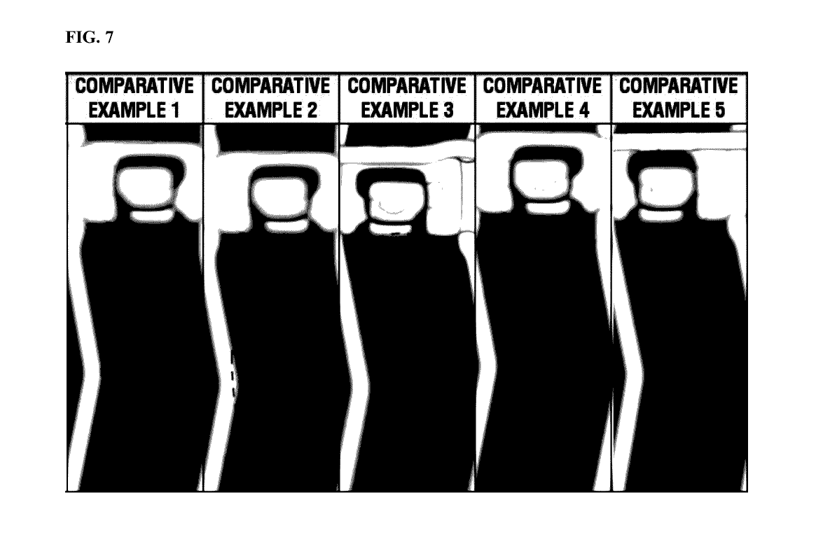

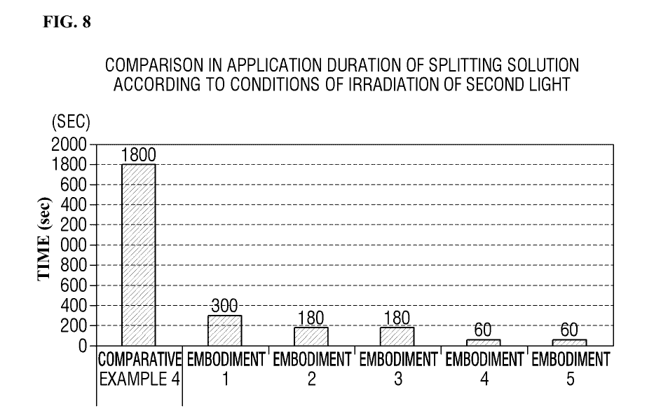

FIG. 6 shows microphotographs of the surfaces of the substrates prepared according to Embodiments 1 to 5. FIG. 7 shows microphotographs of the surfaces of the substrates prepared according to Comparative Examples 1 to 5. FIG. 8 is a graph comparing Embodiments 1 to 5 and Comparative Example 4 for the amount of time that it takes to completely remove a photo-alignment film. As used herein, the term “application duration of a splitting solution”, means the wetting time of a substrate in a splitting solution. It may be determined that the shorter the application duration of a splitting solution, the better the splitting solution's photo-alignment film removal performance, and the lower the amount of damage to the substrate caused by the splitting solution.

Referring to FIGS. 6 and 7, as is apparent from smudges in areas indicated by the broken lines, a photo-alignment film cannot be completely removed from the substrates of Comparative Examples 1 to 3. On the other hand, no such smudges are present in the substrates of Embodiments 1 to 5 or in the substrates of Comparative Examples 4 and 5, which means that the photo-alignment film is completely removed. Embodiments 1 to 5 and Comparative Examples 1 to 5 are further compared with each other, as shown in Table 1 and FIG. 8.

TABLE 1

| | | Removal of |
|---|---|---|
| | Application Duration of | Photo-Alignment |
| | Splitting Solution | Film |
| Embodiment 1 | 300 sec | ◯ |
| Embodiment 2 | 180 sec | ◯ |
| Embodiment 3 | 180 sec | ◯ |
| Embodiment 4 | 60 sec | ◯ |
| Embodiment 5 | 60 sec | ◯ |
| Comparative Example 1 | 900 sec | X |
| Comparative Example 2 | 1200 sec | X |
| Comparative Example 3 | 1500 sec | X |
| Comparative Example 4 | 1800 sec | ◯ |
| Comparative Example 5 | 2100 sec | ◯ |

◯ = complete removal;
X = incomplete removal

Comparing Embodiments 1 to 5, it is clear that the photo-alignment film can be completely removed within 300 seconds or less. More specifically, as the duration of exposure to the second light increases, the application duration of a splitting solution (i.e., the amount of time that it takes to completely remove the photo-alignment film), may decrease. That is, the longer the photo-reactive group of the polymer of the photo-alignment film is exposed to light, the better the photo-alignment film can be decomposed even with a short exposure to a splitting solution.

On the other hand, comparing Comparative Examples 1 to 5, it may be concluded that a minimum of 1800 seconds is required to completely remove the photo-alignment film. That is, the performance of the removal of a photo-alignment film may be considerably decreased in the absence of the use of second light polarized in the second direction as compared to the use of the second light.

### Experimental Example 2

### Comparison in Removal of Photo-Alignment Film According to Composition of Splitting Solution

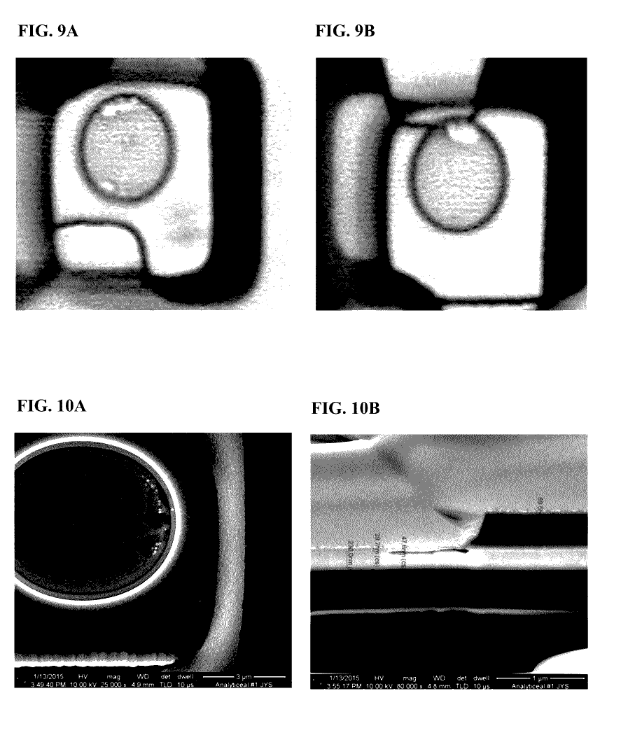

The surface of a substrate prepared according to Comparative Example 6 was observed with a microscope and a focused ion beam-scanning electron microscope (FIB-SEM), and the results of the observation are as illustrated in FIGS. 9 and 10, respectively. FIGS. 9A and 9B show microphotographs of a contact hole portion of the substrate prepared according to Comparative Example 6 taken from different angles. FIGS. 10A and 10B show an FIB-SEM image of the contact hole portion of the substrate prepared according to Comparative Example 6. FIG. 10A is a top view of the contact hole and FIG. 10B is a side view of the contact hole.

Referring to FIGS. 9A and 9B and FIGS. 10A and 10B, in the case of Comparative Example 6, while the photo-alignment film was completely removed even though the application duration of the splitting solution was as short as 360 seconds, however corrosion was detected from a contact hole of the substrate according to Comparative Example 6.

That is, as the content of the alkaline organic component in the splitting solution increases, the splitting solution's ability to remove a photo-alignment film may increase. However, a splitting solution having an increased content of the alkaline organic component may cause corrosion of metallic elements on the substrate such as the source and drain electrodes. As a result, such as splitting solution may not be suitable for use in photo-alignment film reworking.

### Experimental Example 3

### Comparison in Removal of Photo-Alignment Film According to Polarization Direction of Light

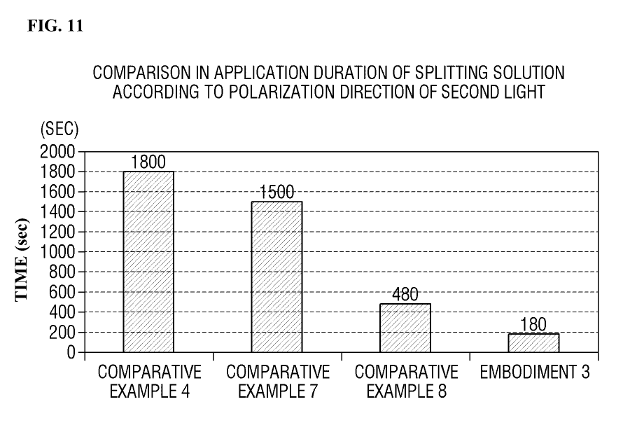

The surfaces of substrates prepared according to Embodiment 3 and Comparative Examples 4, 7 and 8 were observed with a microscope, and the results of the observation are as provided in Table 2 and in FIG. 11. FIG. 11 is a graph comparing the amount of time that it takes to completely remove a photo-alignment film for each of Embodiment 3 and Comparative Examples 4, 7, and 8.

TABLE 2

| | | Removal of |
|---|---|---|
| | Application Duration of | Photo-Alignment |
| | Splitting Solution | Film |
| Embodiment 3 | 300 sec | ◯ |
| Comparative Example 4 | 1800 sec | ◯ |
| Comparative Example 7 | 1500 sec | ◯ |
| Comparative Example 8 | 480 sec | ◯ |

Referring to Table 2, Comparative Example 7, in which a second light polarized in parallel to first light is used to form the photo-alignment film, does not much differ from Comparative Example 4 in terms of the application duration of the splitting solution (i.e., 1500 sec vs. 1800 sec). This may be because the photo-alignment film can be sufficiently photo-decomposed along an axis extended in the first direction, by the first light polarized in the first direction, and as a result, the removal of the photo-alignment film through photodecomposition induced along the same axis during the photo-alignment film removal process is inconsiderable.

On the other hand, when the second light used in the photo-alignment film removal process is polarized in the second direction, which is perpendicular to the first light polarized in the first direction (i.e., the polarization direction of first light irradiated in the photo-alignment film formation process), as in Embodiment 3, the removal of the photo-alignment film can be considerably improved.

If in a photo-alignment film removal process, non-polarized second light is used, as in Comparative Example 8, the removal of a photo-alignment film may be improved when compared to Comparative Example 7, but may still be insufficient when compared to Embodiment 3. This may be because non-polarized second light, even when irradiated with the same exposure amount as in Embodiment 3, may include unaligned components that are not effective for the photo-decomposition of a photo-alignment film.

While the invention has been particularly shown and described with reference to exemplary embodiments thereof, it will be understood by those of ordinary skill in the art that various changes in provide and detail may be made therein without departing from the spirit and scope of the invention as defined by the following claims. The exemplary embodiments should be considered in a descriptive sense only and not for purposes of limitation.

What is claimed is:

1. A method of reworking a photo-alignment film, comprising:
providing a substrate on which a photo-alignment film comprising a photo-reactive group is formed by irradiation of a first light polarized in a first direction, wherein the photo-reactive group comprises cyclobutane dianhydride (CBDA) or a CBDA derivative and diamine;
irradiating a second light polarized in a second direction, which is different from the first direction, onto the photo-alignment film; and
treating the photo-alignment film with a splitting solution.

2. The method of claim 1, wherein providing the substrate, comprises:
preparing the substrate;
coating an alignment agent comprising the photo-reactive group on the substrate;
curing the alignment agent to form the photo-alignment film;
irradiating the first light polarized in the first direction onto the photo-alignment film; and
baking the photo-alignment film.

3. The method of claim 2, wherein curing the photo-alignment film, comprises:
curing the alignment agent at a first temperature for a first amount of time; and
curing the alignment agent at a second temperature higher than the first temperature, for a second amount of time longer than the first amount of time.

4. The method of claim 1, wherein the second direction is perpendicular to the first direction.

5. The method of claim 1, wherein the second light is ultraviolet (UV) light having a wavelength of about 200 nm to about 300 nm.

6. The photo-alignment film reworking method of claim 5, wherein the UV light has an exposure amount of about 0.5 J/cm² to about 5 J/cm².

7. The photo-alignment film reworking method 1, wherein the splitting solution comprises about 15.0% to 19.0% by weight of ethanolamine and about 1.0% to about 5.0% by weight of tetramethylammonium hydroxide.

8. The photo-alignment film reworking method of claim 1, wherein treating the photo-alignment film with the splitting solution comprises treating the photo-alignment film with the splitting solution for about 300 seconds or less.

9. The photo-alignment film reworking method of claim 1, further comprising removing the photo-alignment film after treating the photo-alignment film with the splitting solution, and
washing the substrate with the photo-alignment film removed therefrom.

10. The photo-alignment film reworking method of claim 1, wherein the steps of irradiating the second light and treating the photo-alignment film with the splitting solution are performed at the same time.

11. A method of manufacturing a liquid crystal display, comprising:
providing a substrate on which a photo-alignment film comprising a photo-reactive group is formed by irradiation of first light polarized in a first direction, wherein the photo-reactive group comprises cyclobutane dianhydride (CBDA) or a CBDA derivative and diamine;
inspecting the surface of the photo-alignment film to determine whether the photo-alignment film is defective; and
reworking the photo-alignment film if the photo-alignment film is determined to be defective or forming a liquid crystal layer on the photo-alignment film if the photo-alignment film is determined to be normal,
wherein the reworking the photo-alignment film, comprises:
irradiating a second light polarized in a second direction, which is different from the first direction, onto the photo-alignment film; and
treating the photo-alignment film with a splitting solution.

12. The method of claim 11, wherein providing the substrate, comprises:
preparing the substrate;
coating an alignment agent comprising the photo-reactive group on the substrate;
curing the alignment agent to form the photo-alignment film;
irradiating the first light polarized in the first direction onto the photo-alignment film; and
baking the photo-alignment film.

13. The method of claim 12, wherein curing the photo-alignment film, comprises:
curing the alignment agent at a first temperature for a first amount of time; and
curing the alignment agent at a second temperature higher than the first temperature, for a second amount of time longer than the first amount of time.

14. The method of claim 11, wherein the second direction is perpendicular to the first direction.

15. The method of claim 11, wherein the second light is UV light having a wavelength of about 200 nm to about 300 nm.

16. The method of claim 15, wherein the irradiating the UV light has an exposure amount of about 0.5 J/cm² to about 5 J/cm².

17. The method of claim 11, wherein the splitting solution comprises about 15.0% to about 19.0% by weight of ethanolamine and about 1.0% to about 5.0% by weight of tetramethylammonium hydroxide.

18. The method of claim 11, wherein treating the photo-alignment film with the splitting solution comprises treating the photo-alignment film with the splitting solution for about 300 seconds or less.

19. The method of claim 11, further comprising removing the photo-alignment film after treating the photo-alignment film with the splitting solution, and washing the substrate with the photo-alignment film removed therefrom.

20. The method of claim 11, wherein the steps of irradiating the second light and treating the photo-alignment film with the splitting solution are performed at the same time.
